(19) United States
(12) Patent Application Publication
(10) Pub. No.: US 2009/0044134 A1
(43) Pub. Date: Feb. 12, 2009

(54) DYNAMIC INTERFACES FOR PRODUCTIVITY APPLICATIONS

(75) Inventors: Richard Cave, Camas, WA (US); Simon Ward, Camas, WA (US)

Correspondence Address: ROPES & GRAY LLP, PATENT DOCKETING 39/361, 1211 AVENUE OF THE AMERICAS, NEW YORK, NY, 10036-8704, US

(73) Assignee: Apple Inc, Cupertino, CA (US)

(21) Appl. No.: 12/187,014

(22) Filed: Aug. 6, 2008

Related U.S. Application Data
(60) Provisional application No. 60/963,812, filed on Aug. 6, 2007.

(51) Int. Cl. G06F 3/00

(52) U.S. Cl. 715/762

(57) ABSTRACT

Systems, methods, and computer readable media for providing improved user interfaces for productivity applications are provided. In some embodiments, when a user inputs data into a document, the interface can determine what the format is for that data, such as a text format or an image format. The interface can then remove any presented icons, which can be in the form of a toolbar, not useful for the selected data format and provide icons that are useful for the selected data format. The icons provided can be a predetermined set of icons selected by the designer of the user interface or can be a custom set of icons preselected by a user of the interface.

### CROSS-REFERENCE TO RELATED CASES

This application claims the benefit of U.S. Provisional Patent Application No. 60/963,812, filed Aug. 6, 2007, which is hereby incorporated by reference herein in its entirety.

### FIELD OF THE INVENTION

This can relate to productivity applications and, more particularly, to systems, methods, and computer readable media for providing dynamic interfaces for productivity applications.

### BACKGROUND OF THE DISCLOSURE

Productivity applications, such as word processing applications (e.g., Apple Inc.'s Pages™), database processing applications (e.g., Microsoft Corporation's Access™), spreadsheet applications (e.g., Microsoft Corporation's Excel™), lifestyle applications (e.g., Apple Inc.'s iTunes™, iDVD™, GrageBand™, iChat™, iWeb™, Aperture™, iPhoto™, etc.), just to list a few, are widely known and used to generate and/or interact with data. Productivity applications often have graphic user interfaces featuring icons that a user can “click” using a mouse or other interface device. These icons are often graphic representations of application features available to the user for customizing content that was generated using the productivity application.

Toolbars, which generally include groups of preloaded icons, are frequently used in productivity applications to assist the user. Users can generally customize these toolbars to have desired icons available for common situations. Similarly, palette windows having icons that appear when a user inputs an information type different from a default information type (e.g., when a user inputs an image into a word processing document) are known. However, the presence of too many icons can actually lead to decreased efficiency by cluttering the display of the graphic user interface, thereby requiring the user to spend more time searching for a desired icon. Having too many icons can also be confusing, as the user may be unable to remember the function of each of the displayed icons.

In view of the foregoing, it would be desirable to have methods, systems, and computer readable media for providing a user interface that provides the functionality of multiple toolbars without inundating the user with scores of concurrently displayed icons (some of which are not even selectable and are “grayed-out”).

### SUMMARY OF THE DISCLOSURE

Methods, systems, and computer readable media for providing dynamic interfaces for productivity applications are provided. These methods, systems, and computer readable media include various ways of presenting application features to a user, as well as ways of simplifying the use of certain application features.

For example, a dynamic toolbar can be used that presents icons relevant to user inputs while hiding icons not relevant to those inputs. In some embodiments, when a user inputs information into a user interface of a productivity application document, the interface can determine the format of the information, such as a text format or an image format, and can generate data associated therewith. The productivity application can accordingly update the display of the user interface to include icons (e.g., grouped in a palette and/or toolbar) related to the format data. In other words, the icons displayed by a productivity application can include only those icons that are related to the format of the user information and can omit those icons that are not related to the format of the user information.

Furthermore, there are different ways in which the icon changes can be implemented. In some embodiments, the icon change can be triggered actively (e.g., when a user clicks a mouse button or when a user enters data). In other embodiments, the icon change can be triggered passively (e.g., when a user moves a cursor to a location in the user interface display that is proximate to data of a different format).

In one embodiment, a method of providing a dynamic interface for a productivity application includes displaying one or more first options associated with a first user action type in the dynamic interface, detecting a change in the user action type from the first user action type to a second user action type, removing the one or more first options from within the dynamic interface when the change is detected, and displaying one or more second options associated with the second user action type in the dynamic interface.

In one embodiment, a system for providing a dynamic interface for a productivity application includes a display configured to display within the dynamic interface one or more first options associated with a first user action type, and a processor coupled to the display, wherein the processor is configured to detect a change from the first user action type to a second user action type, remove the one or more first options from within the dynamic interface when the change is detected, and display within the dynamic interface one or more second options associated with the second user action type on the display.

In one embodiment, a computer readable medium for a productivity application includes computer instructions for displaying one or more first options associated with a first user action type in the dynamic interface, detecting a change in the user action type from the first user action type to a second user action type, removing the one or more first options from within the dynamic interface when the change is detected, and displaying one or more second options associated with the second user action type in the dynamic interface.

In one embodiment, a productivity application is implemented on a system. The system includes means for displaying one or more first options associated with a first user action type in the dynamic interface, means for detecting a change in the user action type from the first user action type to a second user action type, means for removing the one or more first options from within the dynamic interface when the change is detected, and means for displaying one or more second options associated with the second user action type in the dynamic interface.

### BRIEF DESCRIPTION OF THE DRAWINGS

The above and other advantages of the present invention will become more apparent upon consideration of the following detailed description, taken in conjunction with the accompanying drawings, in which like reference characters refer to like parts throughout, and in which:

FIG. 1 is a schematic diagram of a computer system that operates in accordance with an embodiment of the present invention;

FIG. 2 is a schematic diagram of a computer system that operates in accordance with an embodiment of the present invention;

FIG. 3 is a flow chart illustrating an exemplary embodiment of a process for utilizing common screen space for options that are of interest to the user in accordance with an embodiment of the present invention; and

FIGS. 4A-4C show illustrative embodiments of user interfaces on a display that utilize common screen space for options that are of interest to the user in accordance with embodiments of the present invention.

### DETAILED DESCRIPTION OF THE DISCLOSURE

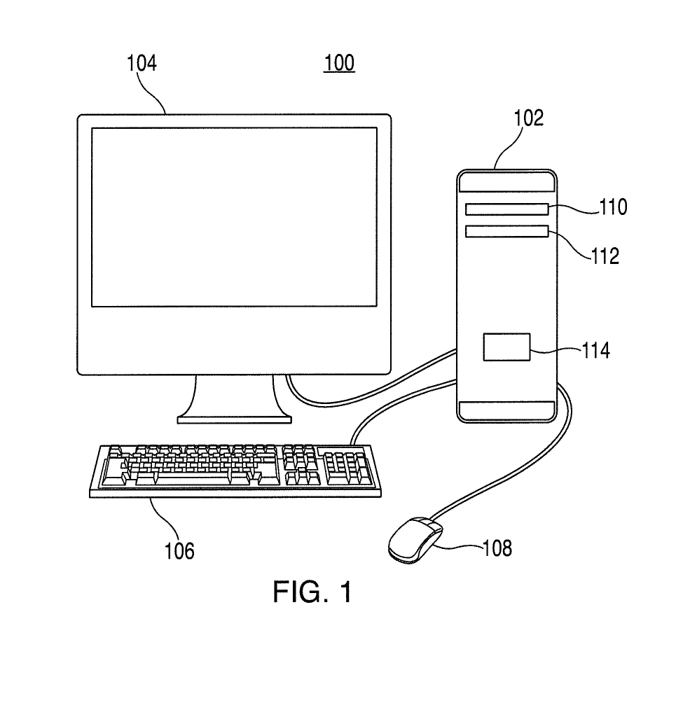

Systems, computer readable media, and methods for providing dynamic interfaces for productivity applications are provided and described with reference to FIGS. 1-4C.

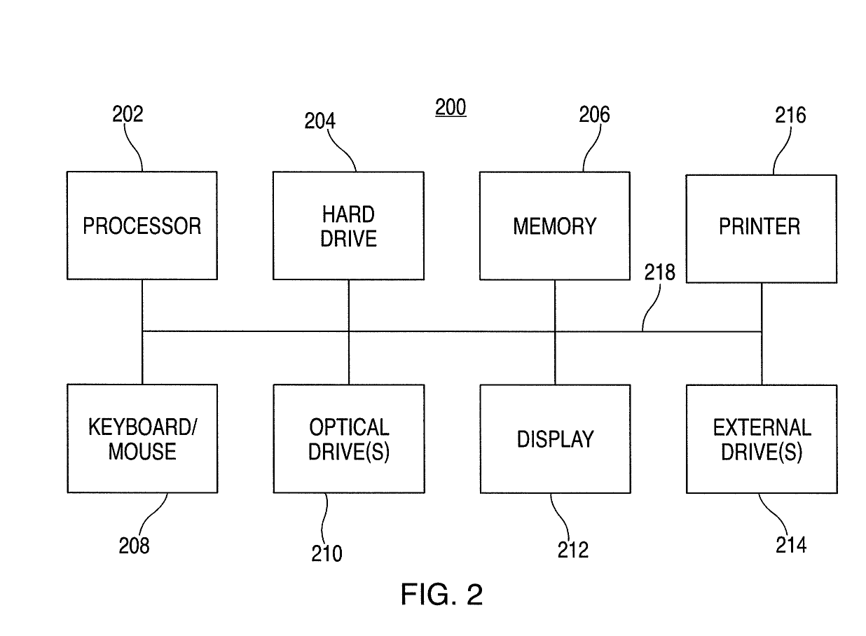

FIG. 1 shows a schematic diagram of a computer system 100, which can be operated in accordance with the principles of the present invention. Computer system 100 may include processor box 102, monitor 104, keyboard 106, and mouse 108. Processor box 102 may include various components, such as those described below with respect to FIG. 2, as well as optical drive 110 and optional optical drive 112. In addition, external drives, such as FLASH sticks or other such devices, may be connected to processor box 102 via one or more ports that are located, in this instance, on a section 114 of the front panel of processor box 102. As set forth in detail below, computer system 100 may be operated in accordance with the principles of the present invention in order to run productivity applications with user interfaces that utilize common screen space for options that are of interest to the user.

FIG. 2 shows computer system 200, which can be a further representation of computer system 100 of FIG. 1. Computer system 200 can include processor 202, hard drive 204, memory 206, keyboard/mouse 208, optical drive(s) 210, display 212, external drive(s) 214, and printer 216. For purposes of illustration, each of the components shown in FIG. 2 is shown coupled to one another via a single bus 218. Persons of ordinary skill in the art will appreciate that, for all practical purposes, computers are currently designed with multiple buses that are interfaced with each other. For example, keyboard/mouse 208 is typically connected to the computer via a USB connection (i.e., a universal serial bus), while the processor and memory communicate via a separate, high-speed bus. Computer system 200 may be operated in accordance with the principles of the present invention in order to assist a user to run productivity applications with user interfaces that utilize common screen space for options that are of interest to the user.

Computer systems 100 and 200 are, in general, widely known. Productivity applications are run on computer systems and used to generate content having different types of information. Different productivity applications include, for example, word processing applications, spreadsheet applications, presentation applications, visual graphic applications (e.g., chart, graph, map, drawing, and image applications), audio applications, multimedia applications (e.g., video applications), and database applications. Productivity applications often have graphic user interfaces featuring icons (e.g., icons grouped together in one or more toolbars or palettes) that a user can use to quickly access productivity application options. When too many icons are present on a display, however, reduced efficiency may result due to the graphic user interface display being cluttered by unnecessary icons.

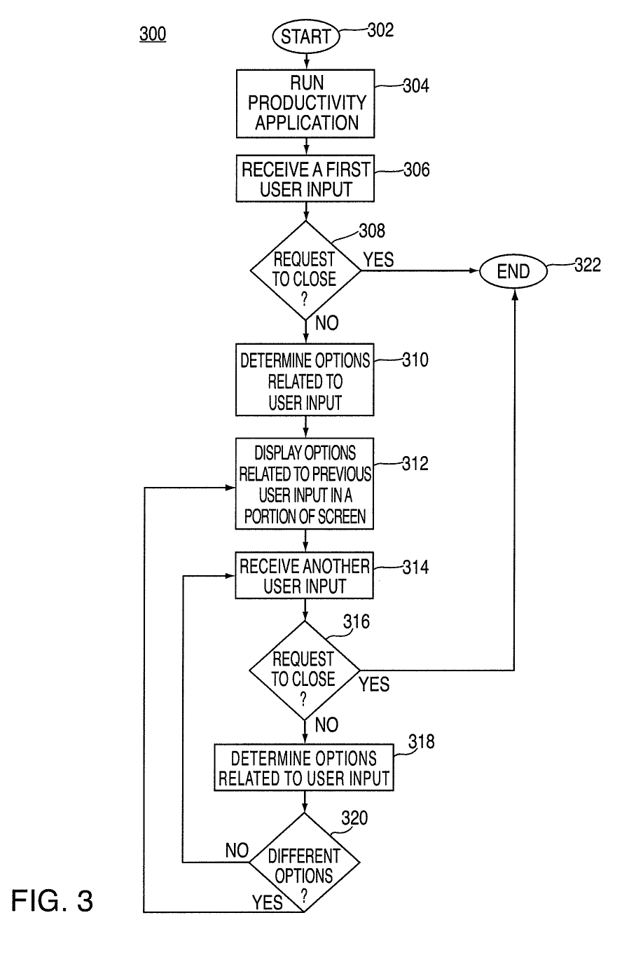

FIG. 3 is a flow chart illustrating an exemplary embodiment of a process 300 for providing a dynamic collection of icons or command options to a user (e.g., on a display device, such as display 212 of FIG. 2). The collection of options can take many forms, including, but not limited to, a menu bar (i.e., a list of menus in an application window), a toolbar (i.e., a group of icons), a menu item (i.e., an icon or text that appears at an end of a menu bar permitting access to options), a context sensitive menu (i.e., a menu that only appears when a user right clicks on a mouse, for example), a palette window (i.e., a menu that floats above all regular window offering application options), and a drop down menu (i.e., a word or icon that provides access to options when clicked).

At step 302, a productivity application may be initialized and, at step 304, the productivity application may be run. When the productivity application is initialized, it can have an interface comprising a default set of options or icons directed towards a common use of the application. For example, a word processing application (e.g., Apple Inc.'s Pages™ or Microsoft Corporation's Word™) can have a toolbar with a default set of icons directed towards editing text. In other embodiments, the interface may not display any icons until the application determines what options are most relevant to the user based on the user's interaction(s) with the application (e.g., a user's selecting a blank document to enter text, inserting a chart into a blank document, etc.).

A first user input may be received at step 306. For example, a word processing application can receive a user input in the form of text information. A user input can include inputting information, which can take one of many forms, including, but not limited to, text information, visual graphic information (e.g., chart, graph, map, drawing, or image information), audio information, multimedia information (e.g., video information), XML (Extensible Markup Language) information, HTML (Hyper Text Mark-Up Language) information, XSL (Extensible Stylesheet Language) information, CSS (Cascading Style Sheet) information, and database information. A user input can also include changing a document's format settings, such as the page setup. A user input can also include selecting previously entered data of a different type, and changing the position of a pointer such that it is located proximate to previously entered data of a different format.

At step 308, the productivity application may determine if the first user input included a request to close the productivity application. If a request to close is detected, then step 322 may be executed and the productivity application may be shut down.

If a request to close is not detected, the productivity application may determine the options related to the first user input at step 310, and may display these options in a portion of a screen of the user interface at step 312. For example, if the user input is image information, icons can be provided giving the user access to commands for changing color, drawing lines, and making erasures. The options can be predetermined by the designer of the user interface, or can be a custom set of icons preselected by the user.

After the options related to the first user input are displayed, the options may remain on the screen until another user input is received at step 314. The user input can take any of the forms described above. The productivity application may then determine if the user input included a request to close the productivity application at step 316. If a request to close is detected, then step 322 may be executed and the productivity application may be shut down.

If a request to close is not detected, the productivity application may determine the options related to the user input from step 314 at step 318. At step 318, the productivity application may further determine whether or not the options related to the user input from step 314 differ from the options displayed at step 312. If the options related to the user input from step 314 do not differ from the options displayed at step 312, then productivity application may execute step 314 and the options displayed at step 312 may remain on the screen until another user input is received at step 314.

For example, in a word processing document containing only text information, a toolbar containing icons related to text information (e.g., icons for color, style, and typeface) could be displayed. If the user input at step 314 comprised inputting text information, the toolbar containing icons related to text information could remain on the screen.

If the options related to the user input from step 314 differ from the options displayed at step 312, then the productivity application may execute step 312, and the options related to the user input from step 314 can be displayed in the same portion of the screen as the options related to the first user input. The options related to the first user input may accordingly be removed. By replacing options automatically (e.g., without direction by the user) in a common screen space, the dynamic interface can improve user efficiency as described above.

For example, in a word processing document containing only text information, a toolbar containing icons related to text information (e.g., icons for color, style, and typeface) could be displayed. If the user input at step 314 comprised inputting image information, the word processing application could erase the icons related to the text information and could cause icons related to image information to be displayed in the same screen space that the icons related to text information had previously occupied. Because the icons related to text information would generally not be used in connection with image information, removing the icons related to text information can improve efficiency by reducing the number of items on the screen.

Although the above discussion deals with a dynamic user interface, in some embodiments there can be a set of fixed icons on the interface that are not responsive to a user's input type. Therefore, for example, icons related to general application functions, such as opening saved documents or saving the open document, can be displayed to the user at all times.

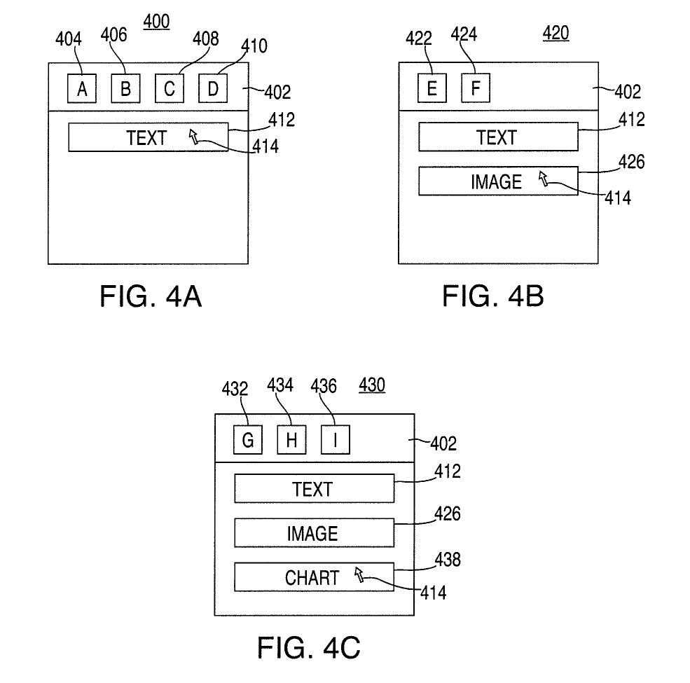

FIGS. 4A-4C show illustrative embodiments of user interfaces on a display that utilize common screen space for options that may be of interest to the user.

FIG. 4A shows display 400 generated by a productivity application that may include text information. Display 400 also includes a dynamic toolbar 402 having exemplary text edit icons (i.e., icon A 404, icon B 406, icon C 408, and icon D 410), which can be found in word processing applications. For example, icon A 404 can correspond to a “color” option, icon B 406 can correspond to a “style” option, icon C 408 can correspond to a “typeface” option, and icon D 410 can correspond to a “font size” option. In response to being selected, each of these icons can cause the productivity application to display a new window and/or adjust an item that is or will be displayed.

The location of pointer 414 (e.g., provided by a keyboard/mouse, such as mouse 208) on a display of a graphic user interface, in an area proximate to text 412, may indicate that a user is currently working in the text of the document. Pointer 414 can be a user input to the productivity application either actively (e.g., when used to click on text 412), or passively (e.g., when positioned proximate to text 412).

FIG. 4B shows display 420 generated by a productivity application that may include text information and image information. Display 420 may also include a dynamic toolbar 402 having exemplary image edit icons (i.e., icon E 422 and icon F 424), which can be found in word processing applications and which may occupy the same screen space as text edit icons 404, 406, 408, and 410 described above. For example, icon E 422 can correspond to a “shading” option, and icon F 424 can correspond to a “freehand draw” option.

In response to being selected, each of these icons can cause the productivity application to display a new window and/or adjust an item that is or will be displayed. The location of pointer 414 in an area proximate to image 426 may indicate that a user is currently working in image 426. If, for example, a user moves pointer 414 to an area proximate to text 412, a passive user input could be detected, and icons 404, 406, 408, and 410 could appear and replace icons 422 and 424 on toolbar 402.

FIG. 4C shows display 430 generated by a productivity application that may include text information, image information, and chart information. Display 430 may also include a dynamic toolbar 402 having exemplary chart edit icons (i.e., icon G 432, icon H 434, and icon I 436), which can be found in word processing applications and which may occupy the same screen space as text edit icons 422 and 424 described above. For example, icon G 432 can correspond to a “formula” option, icon H 434 can correspond to an “insert column” option, and icon I 436 can correspond to an “insert row” option.

In response to being selected, each of these icons can cause the productivity application to display a new window and/or adjust an item that is or will be displayed. The location of pointer 414 in an area proximate to chart 438 can indicate that a user is currently working in chart 438. If, for example, a user moves pointer 414 to an area proximate to text 412, a passive user input could be detected, and icons 404, 406, 408, and 410 could appear and replace icons 432, 434, and 436 on toolbar 402. Likewise, if a user moves pointer 414 to an area proximate to image 426, a passive user input could be detected, and icons 422 and 424 could appear and replace icons 432, 434, and 436 on toolbar 402.

While preferred illustrative embodiments of the invention are described above, it will be apparent to one skilled in the art that various changes and modifications can be made therein without departing from the invention. The appended claims are intended to cover all such changes and modifications that fall within the true spirit and scope of the invention.

What is claimed is:

1. A method of providing a dynamic interface for a productivity application comprising:
displaying one or more first options associated with a first user action type in the dynamic interface;
detecting a change in the user action type from the first user action type to a second user action type;
removing the one or more first options from within the dynamic interface when the change is detected; and
displaying one or more second options associated with the second user action type in the dynamic interface.

2. The method of claim 1, wherein the dynamic interface takes the form of any one of a menu bar, a toolbar, a menu item, a context sensitive menu, and a palette window.

3. The method of claim 1, wherein the change comprises a user clicking on a different data type.

4. The method of claim 1, wherein the change comprises a user moving a pointer proximal to a different data type.

5. The method of claim 1, wherein the change comprises a user inputting data in the form of at least one of word processing content, spreadsheet content, presentation content, visual graphic content, audio content, multimedia content, XML content, HTML content, XSL content, CSS content, content from another application, and database content.

6. The method of claim 1, wherein the change comprises a user changing formatting options.

7. A system for providing a dynamic interface for a productivity application, comprising:
a display configured to display within the dynamic interface one or more first options associated with a first user action type; and
a processor coupled to the display, wherein the processor is configured to detect a change from the first user action type to a second user action type, remove the one or more first options from within the dynamic interface when the change is detected, and display within the dynamic interface one or more second options associated with the second user action type on the display.

8. The system of claim 7, wherein the dynamic interface takes the form of any one of a menu bar, a toolbar, a menu item, a context sensitive menu, and a palette window.

9. The system of claim 7, further comprising a user input device coupled to the processor, wherein the user input device is configured to control a pointer on the display, and wherein the change comprises a user clicking on a different data type using the pointer.

10. The system of claim 7, further comprising a user input device coupled to the processor, wherein the user input device is configured to control a pointer on the display, and wherein the change comprises a user moving the pointer proximal to a different data type.

11. The system of claim 7, wherein the change comprises a user inputting data in the form of at least one of word processing content, spreadsheet content, presentation content, visual graphic content, audio content, multimedia content, XML content, HTML content, XSL content, CSS content, content from another application, and database content.

12. The system of claim 7, wherein the change comprises a user changing formatting options.

13. A computer readable medium for a productivity application, comprising computer instructions for:
displaying one or more first options associated with a first user action type in the dynamic interface;
detecting a change in the user action type from the first user action type to a second user action type;
removing the one or more first options from within the dynamic interface when the change is detected; and
displaying one or more second options associated with the second user action type in the dynamic interface.

14. The computer readable medium of claim 13, wherein the dynamic interface takes the form of any one of a menu bar, a toolbar, a menu item, a context sensitive menu, and a palette window.

15. The computer readable medium of claim 13, wherein the change comprises a user clicking on a different data type.

16. The computer readable medium of claim 13, wherein the change comprises a user moving a pointer proximal to a different data type.

17. The computer readable medium of claim 13, wherein the change comprises a user inputting data in the form of at least one of word processing content, spreadsheet content, presentation content, visual graphic content, audio content, multimedia content, XML content, HTML content, XSL content, CSS content, content from another application, and database content.

18. The computer readable medium of claim 13, wherein the change comprises a user changing formatting options.

19. A productivity application implemented on a system, the system comprising:
means for displaying one or more first options associated with a first user action type in the dynamic interface;
means for detecting a change in the user action type from the first user action type to a second user action type;
means for removing the one or more first options from within the dynamic interface when the change is detected; and
means for displaying one or more second options associated with the second user action type in the dynamic interface.

20. The system of claim 19, wherein the dynamic interface takes the form of any one of a menu bar, a toolbar, a menu item, a context sensitive menu, and a palette window.

21. The system of claim 19, wherein the change comprises means for a user to click on a different data type.

22. The system of claim 19, wherein the change comprises means for a user to move a pointer proximal to a different data type.

23. The system of claim 19, wherein the change comprises means for a user to input data in the form of at least one of word processing content, spreadsheet content, presentation content, visual graphic content, audio content, multimedia content, XML content, HTML content, XSL content, CSS content, content from another application, and database content.

24. The system of claim 19, wherein the change comprises means for a user to change formatting options.
